(19) United States
(12) Patent Application Publication
(10) Pub. No.: US 2013/0065425 A1
(43) Pub. Date: Mar. 14, 2013

(54) ELECTRICAL CONNECTOR ASSEMBLY WITH FIELD TERMINABLE INSULATION DISPLACEMENT CONTACT

(71) Applicants: Michael KUEHNER, Kleinkarlbach (DE); Theodor Harald KAUTZ, Raeren (BE); Marek LUKSIC, Dillsburg, PA (US); George PETERS, JR., Harrisburg, PA (US); Micheal WILBOURN, Hummelstown, PA (US); Leigh MAROLF, Harrisburg, PA (US)

(72) Inventors: Michael KUEHNER, Kleinkarlbach (DE); Theodor Harald KAUTZ, Raeren (BE); Marek LUKSIC, Dillsburg, PA (US); George PETERS, JR., Harrisburg, PA (US); Micheal WILBOURN, Hummelstown, PA (US); Leigh MAROLF, Harrisburg, PA (US)

(73) Assignees: TYCO ELECTRONICS CORPORTION, Berwyn, PA (US); TYCO ELECTRONICS RAYCHEM BVBA, Kessel-Lo (BE); TYCO ELECTRONICS AMP GMBH, Bensheim (DE)

(21) Appl. No.: 13/231,342

(22) Filed: Sep. 13, 2011

(51) Int. Cl. H01R 4/24; H01R 43/00

(52) U.S. Cl. 439/395; 29/825

(57) ABSTRACT

The electrical connector assembly for field terminable connections includes a housing, switch assembly, at least one open channel, at least one insulated wire, and removable cover. Switch assembly is arranged and disposed within housing and includes at least one contact. At least one open channel is disposed within housing and aligned with at least one contact. At least one insulated wire includes insulation layer and conductive core and is arranged and disposed within at least one open channel and is adjacent to at least one contact. Removable cover for housing includes at least one protrusion arranged and disposed to cooperate with at least one open channel, at least one contact and at least one insulated wire. Securing removable cover with housing causes protrusion to penetrate insulation layer on at least one insulated wire to form electrical contact between the respective conductive core and the respective contact.

### FIELD OF THE INVENTION

The present invention is directed to an electrical connector assembly for providing electrical connection without the need for tooling. In particular, the invention is directed to providing electrical connection for applications such as, but not limited to, appliances, medical applications, auto applications, datacom applications, and Machinery & Equipment and Factory Automation (MEFA) applications.

### BACKGROUND OF THE INVENTION

As the number of electrical appliances increases, the use of electrical connectors also increases. The use of electrical connectors to establish electrical connections can be established using snap action switches having contacts that are soldered to exposed/stripped wire. Electrical connection between components is also established by crimping or fastening stripped wires together.

However, each of these methods used to establish an electrical connection requires additional labor, additional tooling and some specialized skills to establish the connection. Therefore, as more and more electrical connections are required it becomes necessary to provide electrical contacts and electrical connections that further enhance the assembly processes of components and allows for ease of installment and use.

It would therefore be beneficial to provide an electrical connector assembly which allows for toolless and reliable field terminable electrical connection. In so doing, the electrical connection can be made without any wire stripping, crimping, soldering and without the use of any wire striping and crimping tools in the field, thereby reducing cost and allowing for a reliable electrical connection that can be easy installed in the field.

### SUMMARY OF THE INVENTION

An exemplary embodiment is directed to an electrical connector assembly having a housing, a switch assembly, and a removable cover. The switch assembly is arranged and disposed within the housing and has at least one contact or terminal. The at least one open channel is disposed within the housing and aligned with the at least one contact or terminal. The removable cover for the housing includes at least one protrusion. The at least one protrusion is arranged and disposed to cooperate with the at least one open channel and the at least one contact or terminal. Securing the removable cover with the housing penetrates an insulation layer of an at least one insulated wire having a conductive core, the insulated wire is arranged and disposed within the at least one open channel, and is proximate to the at least one contact or terminal. Securing and penetrating form electrical contact between the respective conductive core and the respective contact or terminal.

An exemplary embodiment is directed to an electrical connector assembly having a housing, a snap switch assembly, at least one insulated wire, and a removable cover. The snap switch assembly is arranged and disposed within the housing and has at least one insulation displacement contact. The at least one open channel is disposed within the housing and aligned with the at least one insulation displacement contact. The at least one insulated wire has an insulation layer and a conductive core and is arranged and disposed within the at least one open channel and proximate to the at least one insulation displacement contact. The removable cover of the housing has at least one protrusion, the at least one protrusion is arranged and disposed to cooperate with the at least one open channel, the at least one insulation displacement contact, and the at least one insulated wire. Securing the removable cover with the housing causes the at least one insulation displacement contact to penetrate the insulation layer on the at least one insulated wire situated therein, thereby forming electrical contact between the respective conductive core and the respective insulation displacement contact.

An exemplary embodiment is directed a method of providing toolless electrical connection between conductors. The method includes providing a housing having a switch assembly arranged and disposed within the housing and at least one open channel disposed within the switch assembly having at least one contact or terminal. The method includes providing at least one insulated wire having an insulation layer and a conductive core. The method includes arranging and disposing the at least one insulated wire in the at least one open channel and proximate the at least one contact. The method includes positioning a removable cover over the housing, the removable cover having at least one protrusion, the protrusions arranged and disposed on the removable cover to cooperate with the at least one open channel, the at least one contact, and the at least one insulated wire. The method includes securing the removable cover with the housing, wherein the force exerted by securing causes the at least one contact to penetrate the insulation layer on the at least one insulated wire situated therein and wherein electrical contact is formed between the respective conductive core and the respective contact or terminal.

Other features and advantages of the present disclosure will be apparent from the following more detailed description of the preferred embodiment, taken in conjunction with the accompanying drawings which illustrate, by way of example, the principles of the disclosure.

### BRIEF DESCRIPTION OF THE DRAWINGS

FIG. 1 is a front perspective view of an exemplary electrical connector assembly with removable cover.

FIG. 2 is a back perspective view of the exemplary electrical connector assembly of FIG. 1.

FIG. 3 is partial top view of the electrical connector assembly shown without the switch assembly cover and removable cover of FIG. 1.

FIG. 4 is a bottom view of the removable cover of the electrical connector assembly.

FIG. 5 is side view of FIG. 4 of the removable cover of the electrical connector assembly.

FIG. 6 is a perspective view of an exemplary subminiature switch assembly of the present disclosure.

FIG. 7 is a flow diagram of the method of providing toolless electrical connection between conductors of the present disclosure.

### DETAILED DESCRIPTION OF THE INVENTION

In the following detailed description, numerous specific details are set forth in order to provide a thorough understanding of various embodiments. However, those skilled in the art will understand that the embodiments may be practiced without these specific details, that the embodiments are not limited to the depicted embodiments, and that the embodiments may be practiced in a variety of alternative embodiments. In other instances, well known methods, procedures, and components have not been described in detail. The reference to “top” or “bottom” is only a reference to orientation, and should not be construed to be limiting to that particular reference or view.

Further, various operations may be described as multiple discrete steps performed in a manner that is helpful for understanding the embodiments. However, the order of description should not be construed as to imply that these operations need be performed in the order they are presented, or that they are even order-dependent. Moreover, repeated usage of the phrase “in an embodiment” does not necessarily refer to the same embodiment, although it may. Lastly, the terms “comprising,” “including,” “having,” and the like, as used in the present application, are intended to be synonymous unless otherwise indicated.

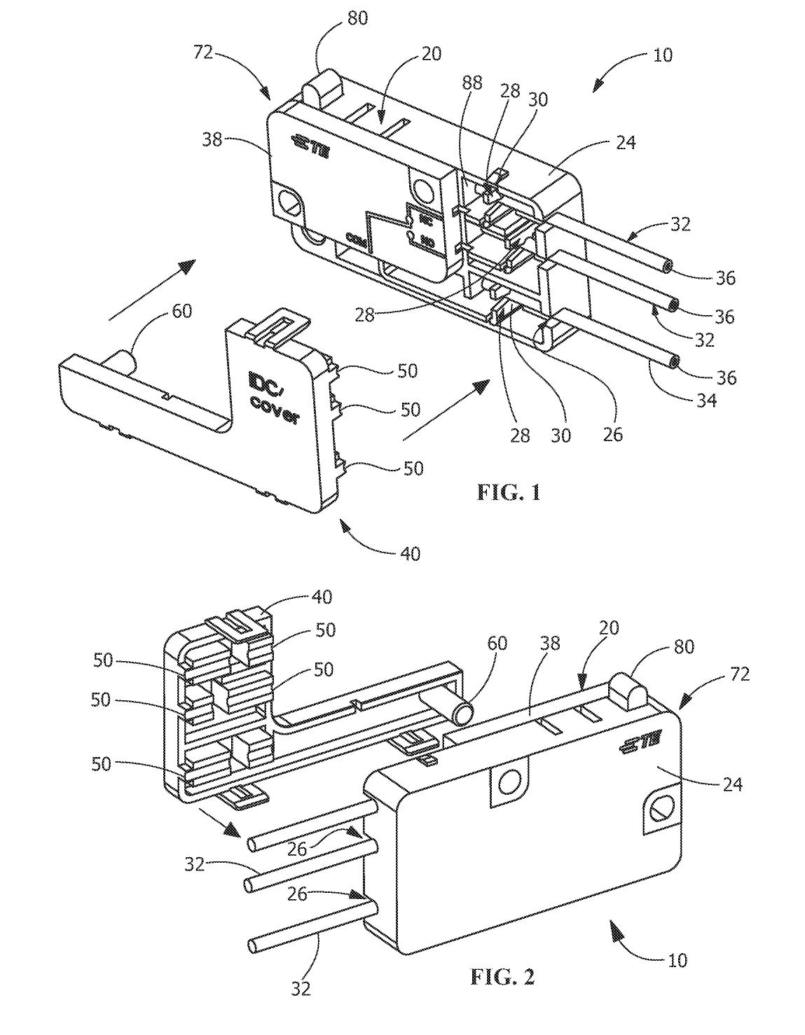

Referring to FIGS. 1 and 2, a perspective view of an embodiment of an electrical connector assembly 10 is illustrated. The electrical connector assembly 10 has a housing 24, a switch assembly 20 and a removable cover 40. The switch assembly 20 is arranged and disposed within the housing 24 and includes at least one contact or terminal 28. At least one open channel 26 is disposed within the housing 24 and aligned with the at least one contact or terminal 28 for receiving at least one insulated wire 32. The at least one insulated wire 32 has an insulation layer 34 and a conductive core 36. The at least one insulated wire 32 is arranged and disposed within the at least one open channel 26 and is adjacent to at least one contact or terminal 28. The removable cover 40 for the housing 24 has at least one protrusion 50. The protrusion 50 of the removable cover 40 is arranged and disposed to cooperate with the at least one open channel 26, the at least one contact or terminal 28 and the at least one insulated wire 32 when the removable cover 40 cooperates with the housing 24. Securing the removable cover 40 with the housing 24 penetrates the insulation layer 34 on the at least one insulated wire 32 to form electrical contact between the respective conductive core 36 and the respective contact or terminal 28. No special tooling or wire stripping mechanisms are needed to form electrical contact between the conductive core 36 and the contact or terminal 28. In one embodiment, as shown in FIG. 1, the contact or terminal 28 is an insulation displacement contact which is generally known in the art.

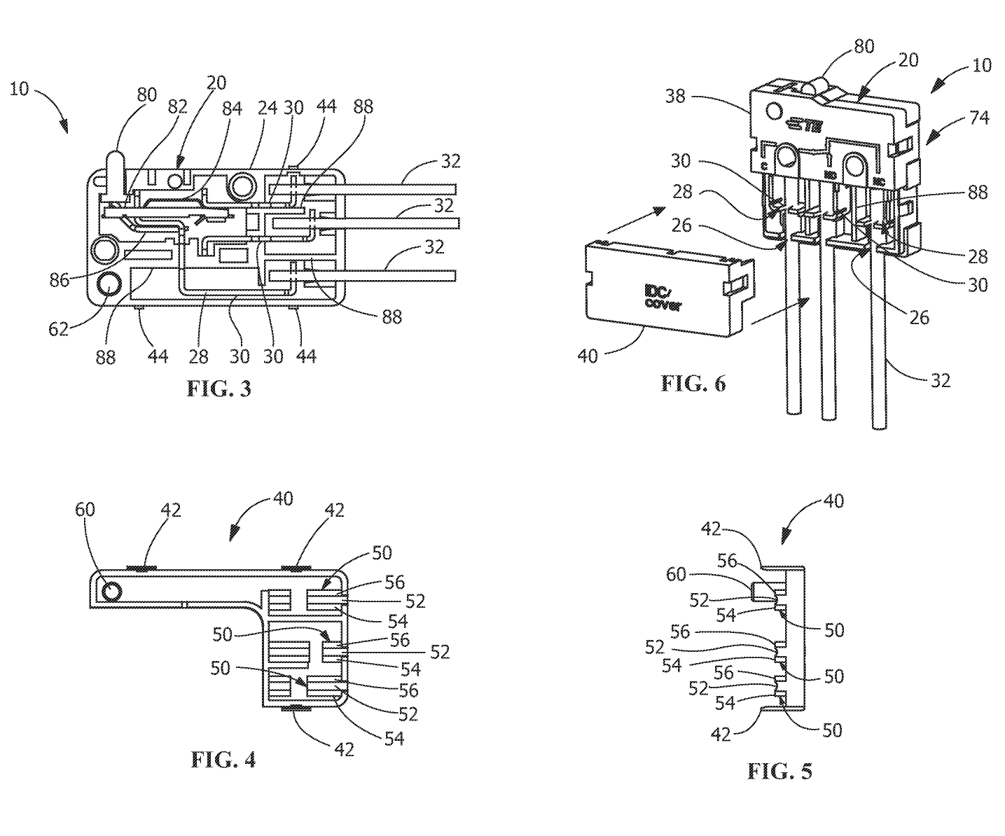

As shown in FIG. 3, the switch assembly 20 is disposed within the housing 24. In one embodiment, the housing is integrally formed as a single piece. As shown in FIGS. 1 and 3, the housing 24 includes a plurality of non-conductive pre-formed members 88 for holding or securing the various components of the electrical connector assembly 10. In one embodiment, as shown in FIG. 3, the housing includes at least one latch holding member 44 that frictionally cooperate with cover latches 42 to secure that removable cover 40 to the housing 24. The housing 24 also includes a receiving member 62 for receiving and securing connecting member 60 of the removable cover 40 to the housing 24. In one embodiment, the housing 24 is generally constructed from a non-conductive material, such as, but not limited to glass, plastic, ceramics, and combinations thereof.

Still referring to FIG. 3, in one embodiment, the switch assembly 20 is a snap action switch assembly. The snap action switch assembly 20 includes a plunger or button 80, a movable contact 82, a spring 84 and a lever 86. The snap action switch 20 operates through the actuation and deactuation of the button 80, which is well known in the art. The button 80, movable contact 82, spring 84 and lever 86 cooperate to establish or break the electrical contact in the electrical connector assembly 10. In another embodiment, the switch assembly is an on/off switch assembly, or a side switch assembly.

As shown in FIG. 4, the removable cover 40 of the electrical connector assembly 10 is generally constructed from a non-conductive material, such as, but not limited to glass, plastic, ceramics, and combinations thereof. The removable cover 40 includes at least one connecting member 60, at least one cover latch 42, and at least one protrusion 50. The at least one connecting member 60 is adapted to cooperate with the receiving member 62 located in the housing 24. The at least one cover latch 42 is adapted to frictionally cooperate with the latch holders 44 housing and pre-formed members 88 of the housing 24 to secure the removable cover 40 and the housing 24. In one embodiment, the removable cover 40, including the cover latches 42 and the at least one protrusion 50 located therein, is formed as a single piece. In an alternative embodiment, friction members will frictionally engage the pre-formed members of the housing to secure the removable cover to the housing.

As shown in FIG. 5, the protrusions 50 of the removable cover 40 include a first surface 54 joined to a second surface 56 by an arcuate portion 52. The arcuate portion 52 of the protrusion 50 is adapted to receive a portion of the insulated wire 32. In operation, when the removable cover 40 is aligned with the housing 24, and force is asserted to connect the removable cover 40 and housing 24, the first and second surfaces 54 and 56 and the arcuate portion 52 cooperate with insulated wire 32 to provide force to pierce the insulation layer 34. Piercing of the insulation layer 34 of the wire 32 with the removable cover 24 puts the conductive core 36 of the wire in electrical contact with the contact or terminal 28 without the use of any tools.

In one embodiment, the switch assembly 20 is a miniature switch assembly 72 (see FIGS. 1-2), and in another embodiment the switch assembly 20 is a sub-miniature switch assembly 74 (see FIG. 6). As shown in FIG. 6, a sub-miniature snap action switch assembly 74 according to an embodiment of the present disclosure is provided. The sub-miniature snap action switch assembly 74 includes all the components of the switch assembly described in FIGS. 1-5 above, just on a smaller scale.

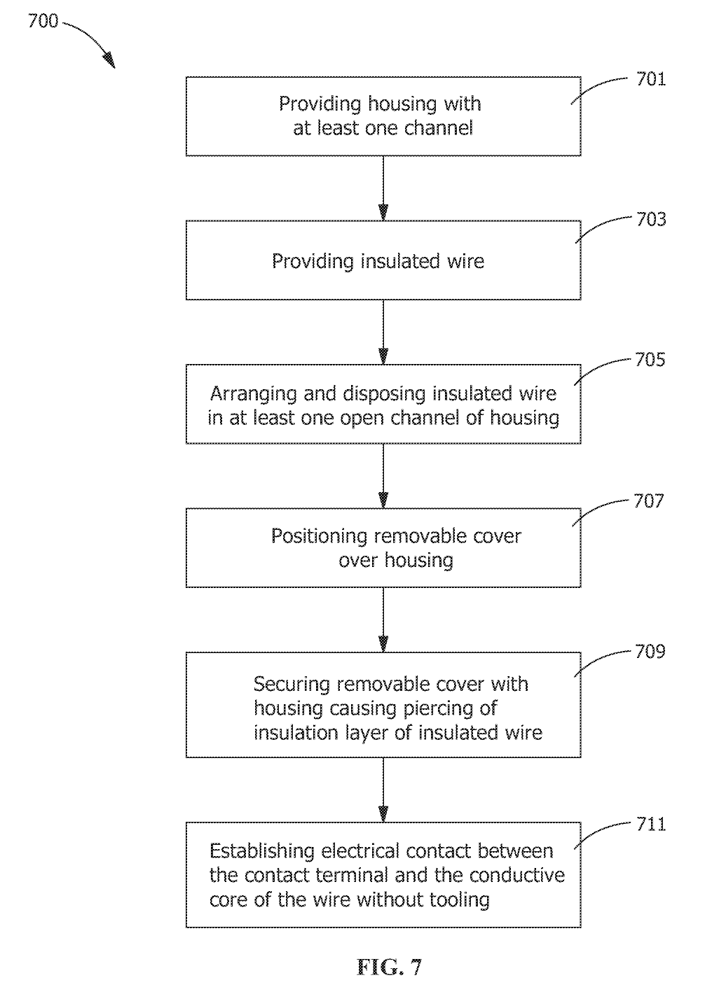

FIG. 7 is a flow diagram of the method 700 of providing toolless electrical connection. The method 700 includes providing a housing 24, step 701 (see FIGS. 1-2). The housing 24 includes a switch assembly 20 arranged and disposed within the housing 24, the switch assembly 20 includes at least one contact or terminal 28 (see FIGS. 1-3). The housing 24 includes at least one open channel 26 disposed within the housing 24 and aligned with the at least one contact or terminal 28 (see FIG. 1). The method includes providing at least one insulated wire 32 having an insulation layer 34 and a conductive core 36, step 703. The method 700 includes arranging and disposing the at least one insulated wire 32 in the at least one open channel 26 and the at least one contact or terminal 28, step 705 (see FIGS. 1-2). The method 700 includes positioning a removable cover 40 over the housing 24, step 707 (see FIGS. 1-2). The removable cover 40 includes at least one protrusion 50 arranged and disposed on the removable cover 40 to cooperate with the at least one open channel 26, and proximate to the at least one contact or terminal 28 and the at least one insulated wire 32. The method includes securing the removable cover 40 with the housing 24, wherein the force exerted by securing causes the at least one contact or terminal to penetrate the insulation layer 34 on the at least one insulated wire 32, step 709. The method includes establishing electrical contact between the respective conductive core 36 of the wire 32 and the respective contact or terminal 28, step 711. Step 709 and step 711 may occur simultaneously.

The use of the electrical connector assembly 10 allows users to establish electrical connection for appliances, medical applications, auto applications, datacom applications, and MEFA applications without having to use additional tools, wire strippers, soldering, wire crimping or other additional materials, time and labor consuming methods. The electrical connector assembly 10 allows for electrical connection without the use of wire stripping or wire stripping tools, resulting in less labor. The electrical connector assembly allows for toolless reliable establishment of an electrical connection. The electrical connector assembly 10 does not require crimping, screwing or solder, resulting in less labor. The electrical connector assembly 10 does not require Faston terminal or solder paste, which reduces material costs. The electrical connector assembly 700 and method of providing electrical connection 700 does not require any tools to establish electrical contact between the conductive wire and the conductive terminals. The method of providing electrical connection 700 requires fewer steps which reduces cycle time. The connector assembly and many of its attendant advantages will be understood from the foregoing description.

While the written description has referred to a preferred embodiment, it will be understood by those skilled in the art that various changes and modifications may be made and equivalents may be substituted for elements thereof without sacrificing its material advantages or without departing from the patentable scope as defined by the claims. Therefore, it is intended that the patentable scope not be limited to the particular embodiments disclosed as the best mode contemplated, but rather other embodiments are intended to be within the scope of the claims if they have structural elements that do not differ from the literal language of the claims, or if they include equivalent structural elements with insubstantial differences from the literal language of the claims.

What is claimed is:

1. A electrical connector assembly comprising:
a housing;
a switch assembly arranged and disposed within the housing, the switch assembly having at least one contact;
at least one open channel disposed within the housing and aligned with the at least one contact; and
a removable cover for the housing having at least one protrusion, the protrusion arranged and disposed to cooperate with the at least one open channel, and the at least one contact; and
wherein securing the removable cover with the housing penetrates an insulation layer of at least one insulated wire, the at least one insulated wire being arranged and disposed within the at least one open channel and proximate to the at least one contact, and wherein electrical contact is formed between the respective conductive core and the respective contact.

2. The electrical connector assembly of claim 1, wherein the switch assembly is a snap switch assembly, an on/off switch assembly, or a side switch assembly.

3. The electrical connector assembly of claim 2, wherein the switch assembly is a miniature switch assembly or a sub-miniature switch assembly.

4. The electrical connector assembly of claim 1, wherein the at least one contact is an insulation displacement contact.

5. The electrical connector assembly of claim 1, wherein the housing is construed from a non-conductive material.

6. The electrical connector assembly of claim 1, wherein the removable cover is constructed from a non-conductive material.

7. The electrical connector assembly of claim 1, wherein the at least one protrusion is integrally formed with the removable cover.

8. The electrical connector assembly of claim 1, wherein the at least one protrusion includes an arcuate dimension for receiving the at least one insulated wire.

9. An electrical connector assembly comprising:
a housing;
a snap switch assembly arranged and disposed within the housing, the snap switch assembly having at least one insulation displacement contact;
at least one open channel disposed within the housing and aligned with the at least one insulation displacement contact;
at least one insulated wire having an insulation layer and a conductive core, the at least one insulated wire arranged and disposed within the at least one open channel and the at least one insulation displacement contact; and
a removable cover for the housing having at least one protrusion, the at least one protrusion arranged and disposed to cooperate with the at least one open channel, the at least one insulation displacement contact and the at least one insulated wire; and
wherein securing the removable cover with the housing causes the at least one insulation displacement contact to penetrate the insulation layer on the at least one insulated wire situated therein and wherein electrical contact is formed between the respective conductive core and the respective insulation displacement contact.

10. The electrical connector assembly of claim 9, wherein the switch assembly is a miniature switch assembly or a sub-miniature switch assembly.

11. The electrical connector of assembly claim 9, wherein the housing is constructed from a non-conductive material.

12. The electrical connector assembly of claim 9, wherein the removable cover is constructed from a non-conductive material.

13. The electrical connector assembly of claim 9, wherein the at least one protrusion is integrally formed with the removable cover.

14. The electrical connector assembly of claim 9, wherein the at least one protrusion includes an arcuate dimension for receiving the at least one insulated wire.

15. A method of providing toolless electrical connection between conductors comprising:
providing a housing comprising:
a switch assembly arranged and disposed within the housing, the switch assembly having at least one contact;
at least one open channel disposed within the housing and aligned with the at least one contact;
providing at least one insulated wire having an insulation layer and a conductive core;
arranging and disposing the at least one insulated wire in the at least one plurality open channel and proximate to the at least one contact;
positioning a removable cover over the housing, the removable cover having at least one protrusion, the protrusions arranged and disposed on the removable cover to cooperate with the at least one open channel, the at least one contact and the at least one insulated wire; and
securing the removable cover with the housing, wherein the force exerted by securing causes the at least one contact to penetrate the insulation layer on the at least one insulated wire situated therein and wherein electrical contact is formed between the respective wire and the respective contact.

16. The method of claim 15, wherein the switch assembly is a snap switch assembly, an on/off switch assembly, or a side switch assembly.

17. The method of claim 16, wherein the switch assembly is a miniature switch assembly or a sub-miniature switch assembly.

18. The method of claim 15, wherein the at least one contact is an insulation displacement contact.

19. The method of claim 15, wherein the housing is constructed from a non-conductive material.

20. The method of claim 15, wherein the at least one protrusion includes an arcuate dimension for receiving the at least one insulated wire.
